(19) United States
(12) Patent Application Publication
(10) Pub. No.: US 2014/0324543 A1
(43) Pub. Date: Oct. 30, 2014

(54) SYSTEMS AND METHODS FOR PROVIDING AN ONLINE VOTING SYSTEM

(71) Applicants: Kyle Heller, West Hollywood, CA (US); Spencer Medof, West Hollywood, CA (US)

(72) Inventors: Kyle Heller, West Hollywood, CA (US); Spencer Medof, West Hollywood, CA (US)

(21) Appl. No.: 13/873,965

(22) Filed: Apr. 30, 2013

(51) Int. Cl. G07C 13/00; G06Q 30/02

(52) U.S. Cl. CPC G07C 13/00; G06Q 30/0204
USPC 705/7.33

(57) ABSTRACT

A system and method for gathering user vote opinion. The method according to one embodiment presents a form representing a vote to a user, the form comprising a topic and a plurality of choices. The method then receives a selection of one of the choices from the user and identifies a plurality of demographic details associated with the user in connection with the selection of one of the choices. The method further associates the selection and demographic details with the vote and stores the selection and demographic details within a selection database. Finally, the method updates aggregate selection data associated with the vote.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Embodiments of the invention disclosed herein generally relate to gathering, analyzing and presenting voting contests. More specifically, the disclosed embodiments relate to systems and methods for allowing users to vote on manually and automatically generated voting contests.

As more users connect to the Internet and World Wide Web, interactions and opinions of users become increasingly prevalent. Currently, major social networking sites provide outlets for users to voice opinions, obtain advice or comments, and generally have discussions with both friends and strangers. In addition to social networking, nearly all blogs and other sites offering content allow users to post comments and discuss the content in one place.

While social networking and other sites allow for free-form content, this free-formed nature results in many conversations being disjointed and difficult to follow. Additionally, the lack of any clear framework or rationale renders these sites unable to capture key metrics regarding users attitudes towards concepts and ideas expressed in users' messages.

Some sites have attempted to incorporate semi-structured, question-type answers in order to allow for ordered communication; however, these solutions have generally failed to address the shortcomings addressed above. For example, crowd-sourced “answers” websites generally result in low-quality, offensive, or irrelevant answers, thus defeating the purpose of asking questions in the first place. Additionally, the current solutions fail to capture any meaningful analytics. While some sites allow users to see how many times a given question has been answered or viewed, the sites fail to analyze deeper metrics and provide intelligible results that can be used for advertising, marketing, or other commercial activities.

### SUMMARY OF THE INVENTION

Generally, embodiments of the present invention provide for systems, methods and computer program products for gathering user vote opinion. One embodiment of the present invention is directed towards a method for presenting a form representing a vote to a user, the form comprising a topic and a plurality of choices. The method then receives a selection of one of the choices from the user and identifies a plurality of demographic details associated with the user in connection with the selection of one of the choices. The method then associates the selection and demographic details with the vote and stores the selection and demographic details. Finally, the method then updates aggregate selection data associated with the vote.

In one embodiment, votes are generated by users while in alternative embodiments votes are automatically generated based on the content of webpages. In embodiments where votes are automatically generated, automatically generating votes based on the content of webpages may be performed periodically. Alternatively, in such embodiments, automatically generating votes based on the content of webpages is performed in response to a request by an owner of the webpages.

In one embodiment, the method further comprises receiving a comment from the user subsequent to receiving a selection of a choice, associating the comment with the vote and the user selection, and storing the comment in a database.

In one embodiment, the method further comprises receiving a request for analytics from a vote owner, the request relating to the vote; identifying a plurality of demographic metrics associated with the vote; aggregating the identifying demographic metrics; and providing a report to the vote owner based on the aggregated metrics. In one embodiment demographics metrics include one or more of the age, gender, location, or income of a user.

In an alternative embodiment, the method further comprises receiving a request for analytics from a vote owner, the request relating to the vote; identifying a plurality of demographic metrics associated with comments associated with the vote; aggregating the identifying demographic metrics; and providing a report to the vote owner based on the aggregated metrics.

Embodiments of the present invention are also directed towards a system comprising a storage device for storing a plurality of votes and a web server. The web server is operative to present a form representing a vote to a user, the form comprising a topic and a plurality of choices. The web server then receives a selection of one of the choices from the user and identifies a plurality of demographic details associated with the user in connection with the selection of one of the choices. The web server then associates the selection and demographic details with the vote and stores the selection and demographic details. Finally, the web server updates aggregate selection data associated with the vote.

In one embodiment, votes are generated by users while in alternative embodiments votes are automatically generated based on the content of webpages. In embodiments where votes are automatically generated, automatically generating votes based on the content of webpages may be performed periodically. Alternatively, in such embodiments, automatically generating votes based on the content of webpages is performed in response to a request by an owner of the webpages.

In one embodiment, the web server further receives a comment from the user subsequent to receiving a selection of a choice, associates the comment with the vote and the user selection, and stores the comment in a comment database.

In one embodiment, the web server further receives a request for analytics from a vote owner, the request relating to the vote; identifies a plurality of demographic metrics associated with the vote; aggregates the identifying demographic metrics; and provides a report to the vote owner based on the aggregated metrics. In one embodiment demographics metrics include one or more of the age, gender, location, or income of a user.

In an alternative embodiment, the web server further comprises receives a request for analytics from a vote owner, the request relating to the vote; identifies a plurality of demographic metrics associated with comments associated with the vote; aggregates the identifying demographic metrics; and provides a report to the vote owner based on the aggregated metrics.

### BRIEF DESCRIPTION OF THE DRAWINGS

The invention is illustrated in the figures of the accompanying drawings, which are meant to be exemplary, and not limiting, in which like references are intended to refer to like or corresponding parts, and in which:

FIG. 1 shows an exemplary embodiment of a system for generating and presenting online voting contests according to one embodiment of the disclosed invention;

FIG. 2 shows an exemplary embodiment of a method for displaying and managing a vote according to one embodiment of the disclosed invention;

FIG. 3 shows an exemplary embodiment of a method for automatically generating a vote from an existing web page according to one embodiment of the disclosed invention;

FIG. 4 shows an exemplary embodiment of a graphical user interface for displaying a vote according to one embodiment of the disclosed invention; and

FIGS. 5A and 5B show exemplary embodiments of a user interface for displaying one or more votes according to one embodiment of the disclosed invention.

### DETAILED DESCRIPTION

In the following description of the preferred embodiments, reference is made to the accompanying drawings that form a part hereof, and in which is shown by way of illustration a specific embodiment in which the invention may be practiced. It is to be understood that other embodiments may be utilized and structural changes may be made without departing from the scope of the disclosed invention.

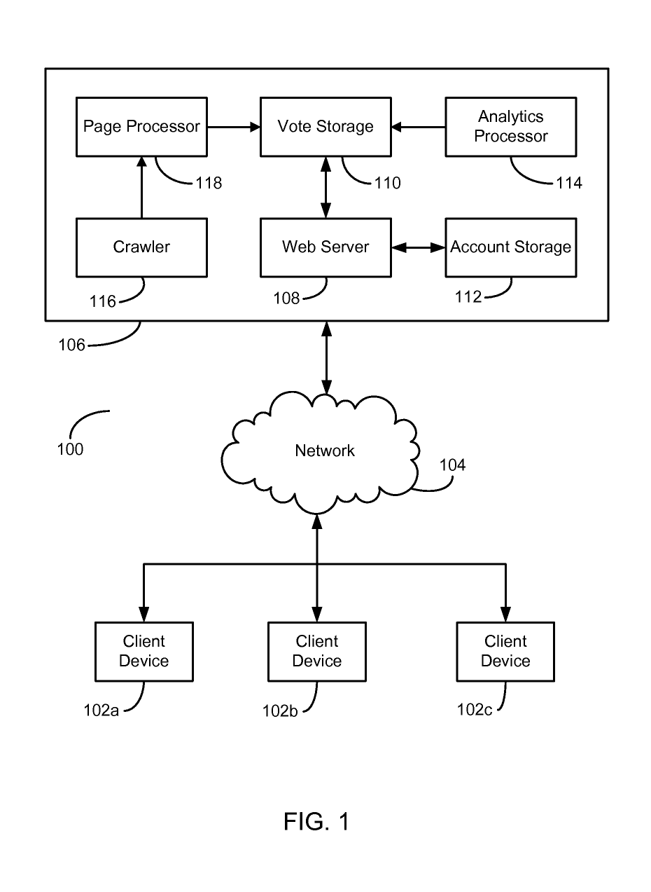

FIG. 1 illustrates one embodiment of a system for generating and presenting online voting contests according to one embodiment. As illustrated, a plurality of client devices 102a, 102b, 102c (referred collectively as “client devices 102”) are communicatively coupled to a voting system 106 via a network 104. In one embodiment, client devices 102 comprise personal computing devices such as laptops, desktop, mobile devices, or any other networked computing devices. In one embodiment, network 104 comprises a wide area network such as the Internet. In alternative embodiments, the network 104 may include a local area network.

Voting system 106 comprises a plurality of devices including a web server 108, vote storage module 110, account storage module 112, analytics processor 114, crawler 116, and page processor 118. Although illustrated as a single system, voting system 106 may comprise multiple physical devices distributed in multiple locations.

Web server 108 provides content to the client devices 102. In one embodiment, web server 108 provides web pages to client devices 102 while in alternative embodiments, web server 108 may provide raw data to client devices 102 such as JSON, XML, or any other serialized data via an application programming interface (“API”). In the illustrated embodiment, web server 108 provides both static files (e.g., JavaScript, stylesheets, images, etc.) as well as dynamically generated content (e.g., HTML generated at the time of request) in response to a request from a user. Additionally, web server 108 contains application-specific logic for handling user requests including data submitted by the user via an HTML FORM element or similar mechanism.

In the illustrated embodiment, web server 108 performs user authentication and registration of voters. Web server 108 utilizes account storage 112 to store and manage user account, which includes details regarding users such as username, passwords, e-mail addresses, and profile information. For example, web server 108 may provide a registration page that allows user to submit a username and password, which is stored by web server 108 within account storage 112. In alternative embodiments, web server 108 may allow a user to “log in” using a third party service such as FACEBOOK or TWITTER. Web server 108 may additionally assign each user a unique identification number in order to quickly identify a user as well as associate users with other aspects of the voting system discussed in further detail herein.

In the illustrated embodiment, web server 108 further handles interactions between client devices 102 and vote storage module 110. Vote storage module 110 stores information relating to votes including vote content, vote options, vote comments, and other metadata associated with vote stored by the system. Web server 108 monitors and controls access to vote storage module 110 through a plurality of pre-defined actions. For example, web server 108 may provide an HTML form allowing client devices 102 to create a new vote. Web server 108 may additionally provide a plurality of other endpoints to allow users to perform additional operations on votes such as updating, reading, or deleting votes. In one embodiment, each of these actions may be accomplished via an HTML form or similar mechanism. Web server 108 may additional perform validation and other actions to ensure the integrity of data stored within vote storage module 110.

In the illustrated embodiment, voting system 106 further comprises an analytics processor 114 communicatively coupled to vote storage module 110. In one embodiment analytics processor 114 may comprise a plurality of applications capable of reading data from the vote storage module 110. For example, analytics processor 114 may comprise a plurality of periodically running applications to analyze the data stored within vote storage module 110 and generate metrics associated with the data within the vote storage module 110. For example, analytics processor 114 may contain an application that periodically inspects all votes created by a given user and generates a report containing voting statistics for a given time period (e.g., all-time or since the application last executed).

In the illustrated embodiment, voting system 106 comprises a crawler 116 that analyzes content from third-party content producers (not shown). In one embodiment, crawler 116 crawls pages periodically. In alternative embodiments, crawler 116 may analyze pages in response to a request from a third-party content producer. In embodiment, crawler 116 may pre-process data retrieved from webpages. For example, crawler 116 may extract page features such as a title and body content of a given webpage and transmit these features to page processor 118.

In the illustrated embodiment, page processor 118 analyzes data received from crawler 116 and generates a vote record for storage in vote storage module 110. In one embodiment, page processor 118 is operative to intelligently extract data from crawled pages. For example, page processor 118 may receive a title and be operative to extract two choices for voting. In alternative embodiments, page processor 118 may be operative to analyze crawled pages for microdata or metadata embedded within the page itself.

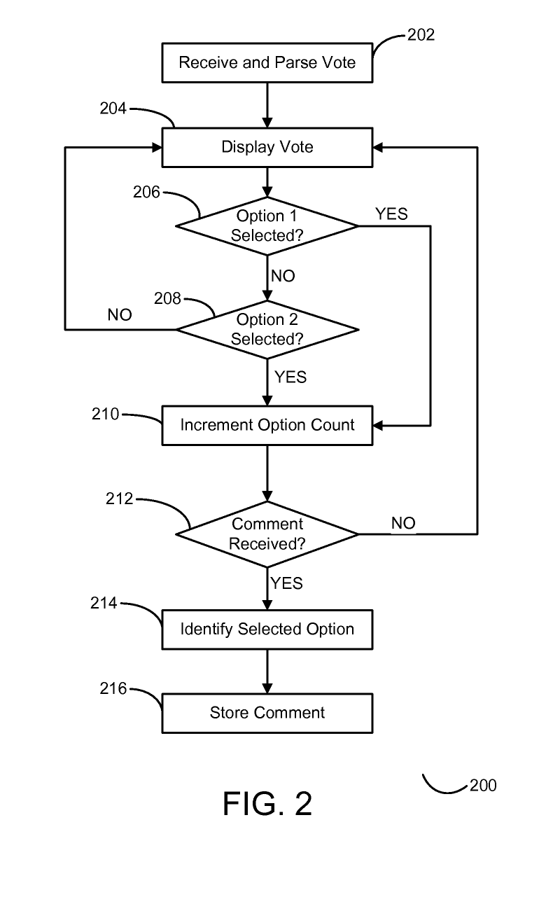

FIG. 2 illustrates one embodiment of a method for displaying and managing a vote according to one embodiment of the disclosed invention. In the illustrated embodiment, the method 200 receives and parses a vote, step 202. As discussed previously, the method may receive voting data from users via an HTML form or API call. Alternatively, as will be discussed further herein, voting data may be received and parsed automatically.

In one embodiment, voting data may comprise a title, description, voting choices, one or more categories, and an expiration date, or a combination thereof. The contents of the voting data may be required to conform to a plurality of validation criteria. For example, the title of a vote and voting choices may be limited to pre-defined lengths, respectively. In another example, voting choices may be limited to only two choices.

After identifying a vote, the method 200 displays the vote, step 204. In one embodiment, displaying a vote comprises transmitting an HTML webpage to a user. In alternative embodiments, displaying a vote may comprise transmitting a serialized representation of a vote to a user. In one embodiment, votes may be displayed in response to a user request for a vote (e.g., selecting a hyperlink). In the alternative, votes may be displayed on a centralized page (e.g., a portal) wherein the user can view multiple votes including “featured” votes associated with advertiser accounts.

After displaying a vote to a user, the method 200 determines if the user selects a first option, step 206, or a second option, step 208. As discussed previously, a vote may comprise two options associated with the question or topic of the vote. For example, a vote may ask users to pick which television show, of two shows, is the best. In one embodiment, the method 200 may require that users be logged in prior to casting a vote in steps 206, 208. In an alternative embodiment, the method 200 may allow “guest” users to cast votes, 206, 208, without requiring the users to be logged in. In this embodiment, the method 200 may assign a “guest” user a unique, temporary identifier or nickname (e.g., “guest12345”). Additionally, if allowing for “guest” votes, the method 200 may utilize a cookie, or similar mechanism, to prevent guest users from voting multiple times. Furthermore, the method 200 may utilize cookies to allow a user to “convert” his or her guest votes to user votes if the user later registered for an account. For example, the method 200 may associate the user's IP address with a unique guest identifier and automatically associate those identified guest votes with a new account from the same IP address.

If the user does not selection either option, the method 200 continues to display the vote, step 204. If, however, the user selects either option, the method 200 increments the option count, step 210. In one embodiment, method 200 increments a counter associated the selected choice for a given vote. Alternatively, or in conjunction with the foregoing, the method 200 may store demographic data regarding the selection of an option. For example, the method 200 may store usernames, locations, dates or times associated with the selection of an option. For example, the method 200 may record a list of users who have selected a given option, each user having an associated profile. In this manner, the method 200 may be able to synthesize a vote count by counting the number of users associated with an option, while maintaining demographic data associated with both a vote as well as the vote options.

The method 200 then determines if a comment has been received for the displayed vote, step 212. In the illustrated embodiment, determining if a comment has been received may occur at any time after a user has selected a vote option. Thus, comments may be received at any time during the lifetime of a vote. If the method 200 does not receive a comment, the method 200 continues to display the vote, step 204. If the method 200 does receive a comment, the method 200 identifies the selected option, step 214.

In one embodiment, a comment may comprise a fixed length string entered by a user into an HTML form or similar mechanism. In one embodiment, a comment is associated with a user's selected option. For example, if a user selects a first option and the user enters a comment, the comment may be associated with the user's selected option so that comments may be organized according to their associated selected options.

After determining the selection option, the method 200 stores the comment, step 216. In one embodiment, storing a comment may comprise storing the comment text as well as a reference to the user making the comment as well as the option the user selected in steps 206, 208. In alternative embodiments, if the user changes his or her option selection, the comment may be updated to reflect the change in option selection. In alternative embodiments, the method 200 may delete or archive the user's comment upon the user changing his or her selection.

As discussed in the embodiment above, the method 200 stores demographic data associated with the life of a vote. In this manner, the method 200 may store data useful in analyzing the users of the vote and their choices. Thus, the method 200 may store demographic data useful in generating high-level analytical data for a given topic in response to a request from a vote owner. For example, if the vote comprises the question “Which do you prefer: COKE or PEPSI?” and contains two options (“COKE” and “PEPSI”), the vote may be utilized to provide analytical data that is valuable to the makers of such products. In one embodiment, the method 200 may store information regarding the location of users who select the options “COKE” or “PEPSI.” In this example, the method 200 may further be able to generate reports illustrating the results. Thus, by storing demographic data, the method 200 may be able to summarize the vote by finding which regions (e.g., states) prefer COKE and what regions prefer PEPSI. Additional examples include identifying the age ranges, income levels, social media usage, gender, etc., of users that prefer “COKE” or “PEPSI.” Thus, as described above, the method 200 may additionally create detailed reports on public opinion regarding the subject of a given vote.

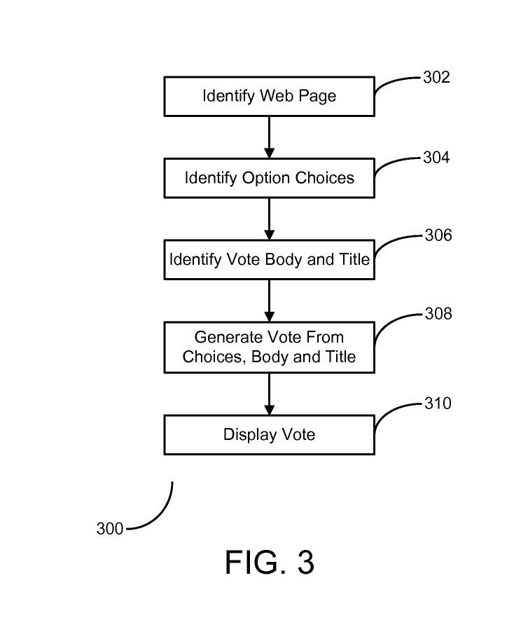

FIG. 3 illustrates a one embodiment of a method for automatically generating a vote from an existing web page according to one embodiment of the disclosed invention. As the embodiment in FIG. 3 illustrates, the method 300 identifies a web page, step 302. As discussed previously, identification of a webpage may be done automatically and on a periodic basis. For example, the method 300 may crawl a known set of pages for a plurality of sites at a predetermined time each day. Alternatively, the method 300 may identify web pages in response to a request from a user such as a publisher. For example, a user may author a blog post and inform the method 300 that the blog post should be crawled and analyzed.

The method 300 next identifies option choices, step 304. In one embodiment, the method 300 analyzes an incoming webpage's textual content to identify option choices. For example, a given webpage may have both a title and body content. The method 300 may analyze the title to determine if the title contains at least two option choices based on removing the title of common stop words (e.g., “the”, “and”, “to”, etc.). The method 300 then may analyze the remaining words for comparison terms such as “or,” “either,” “which.” Finally, the method 300 may then compare the remaining term with a thesaurus of juxtaposed terms. For example, a thesaurus may contain an entry for “COKE” with the terms “PEPSI,” “MOUNTAIN DEW,” “FANTA,” and “WATER” associated with it. Terms may further be groups according to a specifically defined taxonomy. Thus, if a title contains the string “COKE or PEPSI: the debate continues,” the method 300 may remove stop words and convert the string to the tokens “COKE”, “PEPSI,” “debate,” and “continues.” After tokenizing the string, the method 300 may then compare each token to a list of comparative terms and query if those terms also appear in the title. Thus, when analyzing the token “COKE,” the method 300 may then scan the remaining tokens for the presence of one of “PEPSI,” “MOUNTAIN DEW,” “FANTA,” or “WATER.” In this manner, the method 300 can identify that both “COKE” and “PEPSI” appear within the title and are viable option choices.

If the method 300 identifies multiple option choices (or sets of choices), the method 300 may rank the choice based on predetermined criteria such as the position of the terms, the global popularity of the option choices, or similar metrics. Alternatively, the method 300 may perform a similar operation on all terms within the webpage (including the body content). In another embodiment, the method 300 may analyze metadata associated with the webpage in order to determine option choices.

After identifying the option choices, the method 300 then identifies a vote body and title, step 306. As discussed previously and further herein, a vote may comprise a short title as well as a description associated with the vote topic. In one embodiment, the method 300 may extract a title and body content from a webpage using metadata associated with the site. For example, the webpage may specific a “title” and “description” within metadata in a HEAD tag. Alternatively, the method may automatically extract a title and or body from the content of a page. For example, a “title” of a blog post may be utilized for the vote title, while extracts of the blog post content may be utilized for the body of the vote. In alternative embodiments, the title and body may be automatically generated using templates and the detected choices. For example a template for a title may comprise the string “Which do you prefer OPTION1 or OPTION2?” In this example, “OPTION1” and “OPTION2” may be replaced with the options extracted in step 304. In alternative embodiments, the method 300 may additionally extract a category or other metadata from the webpage itself.

After extracting the vote parameters, the method according to one embodiment then generates a vote from the option choices, body, title, and other extracted features, step 308. In one embodiment, generating a vote may comprise formulating the extracted data in a format understand by a database or other storage device. For example, the method 300 may sanitize data prior to the data being stored. Additionally, the method 300 may automatically append additional information to the vote details such as timestamp data or a predefined expiration date. After storing the vote information, the method 300 displays the vote, step 310. Displaying and interacting with a vote is discussed more fully with respect to FIG. 2 and is not repeated herein for the sake of clarity.

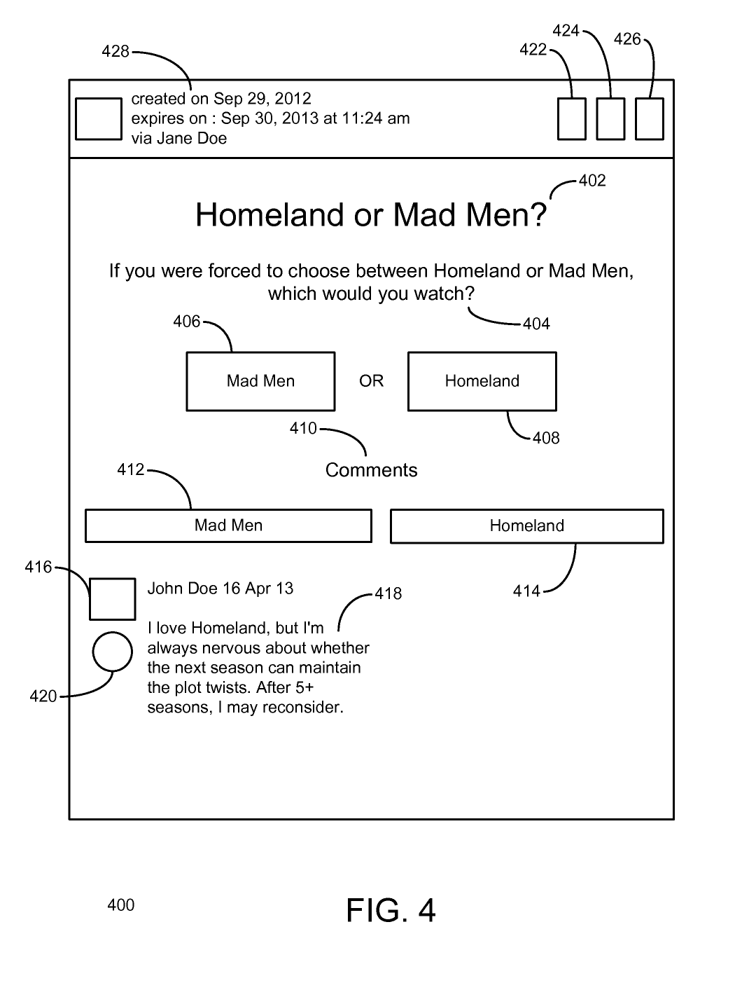

FIG. 4 shows an exemplary embodiment of a graphical user interface for displaying a vote according to one embodiment of the disclosed invention. As illustrated in FIG. 4, a vote may be displayed using a graphical user interface (“GUI”) 400. The GUI contains a plurality of textual and graphical elements including details of the vote as well as interactive elements.

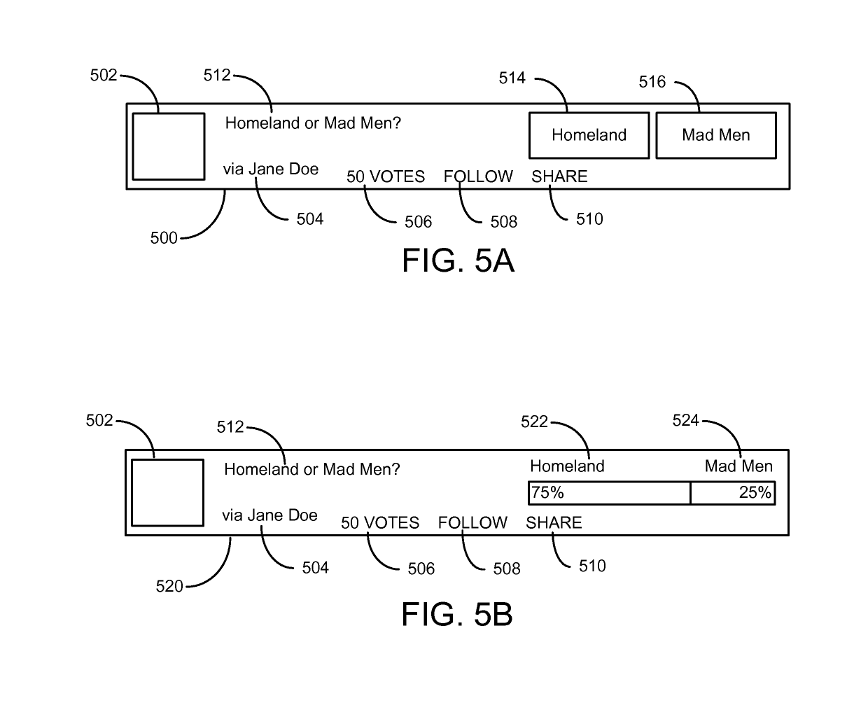

In the illustrated embodiment, GUI 400 contains a header element that contains details about the vote creator and vote itself 428 as well as a plurality of controls 422, 424, 426 for interacting with the vote. In one embodiment, controls 422, 424, 426 may allow other users to share the vote with other users. For example, control 422 may allow users to subscribe or “follow” the vote, control 424 may allow users to share the vote with friends or connections on social media sites and control 426 may allow users to embed the vote within a webpage, as discussed more fully with respect to FIG. 5.

GUI 400 contains the title 402 of the vote as well as a brief description of the vote 404. As previously discussed, a title 402 comprises a short description of the vote and may be limited to a predefined number of characters. Additionally, as previously discussed, the title 402 may be automatically extracted from a webpage title. For example, title 402 may have been extracted from a webpage entitled “Homeland and Mad Men Lead Critics Pick for Best Television Show.” As can be seen, the title 402 is based upon the key, extracted terms while ignoring the non-comparative terms.

GUI 400 additionally contains a description field 404 which comprises a short description of the vote. In one embodiment, the description provides further information or details regarding the vote that aids users in choosing a selection 406, 408. As discussed previously, the description may be entered by a user, extracted from a webpage, or automatically constructed based on a template.

GUI 400 contains a plurality of controls 406, 408 associated with the option choices for a given vote. In one embodiment, the controls may comprise an HTML link, button, or input element and may be interacted with by the user. Selection of a control 406, 408 transmits a message to the voting system (FIG. 1) and informs the system that a user has registered his or her vote for the given vote. Thus, the message to the voting system may contain an identification of the vote and an identification of the choice. The message may further contain details regarding the user or, alternatively, said details may already be present at the voting system.

One or more comments are displayed in the GUI 400 below the controls 406, 408. As illustrated in the exemplary embodiment of FIG. 4, comments are partitioned in accordance with the number of options available. This partition allows for the grouping of comments according to the choice selected by the commenter. As illustrated in the exemplary embodiment of FIG. 4, a commenter 416 transmits a textual comment 418 to the server that is, in turn, displayed within the GUI 400 on subsequent page views. Each comment may additionally contain an action control 420 that allows other users to interact with the comment. For example, action control 420 may comprise a “thumbs up” button that allows users to increment a counter associated with the comment. In one embodiment, comments may be ranked according to such positive feedback received from other user.

FIGS. 5A and 5B show exemplary embodiments of graphical user interfaces for displaying a vote according to one embodiment of the disclosed invention. FIG. 5A illustrates one embodiment a condensed, or “widget,” view of a vote corresponding to the vote depicted in FIG. 4. In one embodiment, FIG. 5A illustrates the “embed” view of the GUI 400 discussed previously.

As illustrated, the widget 500 contains details regarding the vote in a condensed form including an avatar associated with a user 502, the user name 504, the vote title 512, controls 506, 508, and 510, and votes choices 514 and 516. Controls 514 and 516 enable a user to choose an option similar in function as controls 406 and 408. For example, if a user places widget 500 on a third-party website, a second user may answer the vote by selecting an option 514 or 516 without leaving the third-party site.

When a user selects and option 514 or 516, the widget 500 may update and re-display its contents in a manner depicted in FIG. 5B. Similar to FIG. 5A, the widget 520 contains details regarding the vote in a condensed form including an avatar associated with a user 502, the user name 504, the vote title 512, controls 506, 508, and 510. In contrast to widget 500, the updated widget 520 replaces the controls 514 and 516 with a percentage indicator, which illustrates the percentages of users choosing the vote options associated with controls 514 and 516.

FIGS. 1 through 5 are conceptual illustrations allowing for an explanation of the disclosed invention. It should be understood that various aspects of the embodiments of the disclosed invention could be implemented in hardware, firmware, software, or combinations thereof. In such embodiments, the various components and/or steps would be implemented in hardware, firmware, and/or software to perform the functions of the disclosed invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the disclosed invention to a single embodiment, as other embodiments are possible by way of interchange of some or all of the described or illustrated elements. Moreover, where certain elements of the disclosed invention can be partially or fully implemented using known components, only those portions of such known components that are necessary for an understanding of the disclosed invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the disclosed invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the disclosed invention have been described above, it should be understood that they have been presented by way of example, and not limitation. It would be apparent to one skilled in the relevant art(s) that various changes in form and detail could be made therein without departing from the spirit and scope of the invention. Thus, the disclosed invention should not be limited by any of the above-described exemplary embodiments, but should be defined only in accordance with the following claims and their equivalents.

What is claimed is:

1. A method for gathering user vote opinion, the method comprising:
presenting a form representing a vote to a user, the form comprising a topic and a plurality of choices;
receiving a selection of one of the choices from the user;
identifying a plurality of demographic details associated with the user in connection with the selection of one of the choices;
associating the selection and demographic details with the vote;
storing the selection and demographic details; and
updating aggregate selection data associated with the vote.

2. The method of claim 1 wherein votes are generated by users.

3. The method of claim 1 wherein votes are automatically generated based on the content of webpages.

4. The method of claim 3 wherein automatically generating votes based on the content of webpages is performed periodically.

5. The method of claim 3 wherein automatically generating votes based on the content of webpages is performed in response to a request by an owner of the webpages.

6. The method of claim 1 further comprising
receiving a comment from the user subsequent to receiving a selection of a choice;
associating the comment with the vote and the user selection; and
storing the comment in a database.

7. The method of claim 1 further comprising:
receiving a request for analytics from a vote owner, the request relating to the vote;
identifying a plurality of demographic metrics associated with the vote;
aggregating the identifying demographic metrics; and
providing a report to the vote owner based on the aggregated metrics.

8. The method of claim 1 wherein demographics metrics include one or more of the age, gender, location, or income of a user.

9. The method of claim 1 further comprising:
receiving a request for analytics from a vote owner, the request relating to the vote;
identifying a plurality of demographic metrics associated with comments associated with the vote;
aggregating the identifying demographic metrics; and
providing a report to the vote owner based on the aggregated metrics.

10. The method of claim 9 wherein demographics metrics include one or more of the age, gender, location, or income of a user.

11. A system for gathering user vote opinion, the system comprising:
a storage device for storing a plurality of votes; and
a web server operative to:
present a form representing a vote to a user, the form comprising a topic and a plurality of choices;
receive a selection of one of the choices from the user;
identify a plurality of demographic details associated with the user in connection with the selection of one of the choices;
associate the selection and demographic details with the vote;
store the selection and demographic details within a selection database; and
update aggregate selection data associated with the vote.

12. The system of claim 11 wherein votes are generated by users.

13. The system of claim 11 further comprising a crawler operative to automatically generate votes based on the content of webpages.

14. The system of claim 13 wherein the crawler is operative to automatically generate votes based on the content of webpages periodically.

15. The system of claim 13 wherein the crawler is operative to automatically generate votes based on the content of webpages in response to a request by an owner of the webpages.

16. The system of claim 11 further comprising
receiving a comment from the user subsequent to receiving a selection of a choice;
associating the comment with the vote and the user selection; and
storing the comment in a comment database.

17. The system of claim 11 further comprising:
receiving a request for analytics from a vote owner, the request relating to the vote;
identifying a plurality of demographic metrics associated with the vote;
aggregating the identifying demographic metrics; and
providing a report to the vote owner based on the aggregated metrics.

18. The system of claim 11 wherein demographics metrics include one or more of the age, gender, location, or income of a user.

19. The system of claim 11 further comprising:
receiving a request for analytics from a vote owner, the request relating to the vote;
identifying a plurality of demographic metrics associated with comments associated with the vote;
aggregating the identifying demographic metrics; and
providing a report to the vote owner based on the aggregated metrics.

20. The system of claim 19 wherein demographics metrics include one or more of the age, gender, location, or income of a user.
